(19) United States
(12) Patent Application Publication
(10) Pub. No.: US 2007/0007840 A1
(43) Pub. Date: Jan. 11, 2007

(54) Centrifugal water pump having polar anisotropic magnetic ring

(75) Inventors: Wen-Chuan Chen, Yaoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/247,182

(22) Filed: Oct. 12, 2005

(30) Foreign Application Priority Data
Jul. 6, 2005 (TW) 94122791

(51) Int. Cl. H02K 21/12

(52) U.S. Cl. 310/156.43

(57) ABSTRACT

A centrifugal water pump comprises a rotor having a polar anisotropic magnetic element. Magnetic force lines are centrally distributed at the inner or outer surface of the polar anisotropic magnetic ring to obtain high magnetic flux density and shortest magnetic line path to increase output efficiency when the polar anisotropic magnetic ring is coupled to the stator. The polar anisotropic magnetic ring is made of ferrite; thus rust and chemical erosion of the polar anisotropic magnetic ring can be prevented when the magnetic ring is used in water and no additional water-proofing element is required.

### BACKGROUND

The invention relates to a centrifugal water pump having a polar anisotropic magnetic ring, and in particular to a centrifugal water pump having a ferrite polar anisotropic magnetic ring to output a large amount of water at high pressure.

In general, a magnetic ring of a rotor for a conventional centrifugal water pump can be fabricated by plastic injection or tiled magnets with polar anisotropy.

FIG. 1 shows the distribution of magnetic force lines emitted from a conventional anisotropic plastic magnet. The direction of magnetic field of the magnet extends outwardly and radially. With the limitation of material and manufacturing methods of the magnet, however, the plastic-injected magnet has a low magnetic property and long magnetic line path, i.e., low magnetic flux density. Thus, the pump cannot output a large amount of water at high pressure.

FIG. 2A is a schematic view of a single tiled magnet, and FIG. 2B shows the distribution of magnetic force lines emitted from a circular anisotropic element formed by a plurality of tiled magnets. The direction of magnetic field of the assembled tiled magnets extends outwardly and radially. When the tiled magnets are assembled into a ring, however, concentricity and roundness of the ring are unqualified due to the aggregated errors resulting from allowance of each tiled magnet. Further, clearances are formed between the tiled magnets of the ring, resulting in an inconsistent magnetic field, the increase of magnetic resistance and the improper coupling of Hall elements. As with the plastic-injected magnet in FIG. 1, the ring formed by the tiled magnets also provides a low magnetic property and long magnetic line path, thus the pump cannot output a large amount of water at high pressure.

### SUMMARY

The invention provides a centrifugal water pump comprising a rotor having a polar anisotropic magnetic ring. Magnetic force lines are distributed at least one surface of the polar anisotropic magnetic ring so as to obtain high magnetic flux density and the shortest magnetic line path for increasing output efficiency and providing large output efficiency when the polar anisotropic magnetic ring is coupled to the stator.

The polar anisotropic magnetic ring is made of ferrite; thus rust and chemical erosion of the polar anisotropic magnetic ring can be prevented when the ferrite magnetic ring is used in water and no additional water-proofing element is required.

The centrifugal water pump of the invention comprises a housing, a rotor and a stator. The housing comprises an inlet and an outlet. The rotor disposed in the housing comprises a polar anisotropic magnetic element. The stator disposed in the housing with respect to the polar anisotropic magnetic element of the rotor provides electromagnetic force for driving the rotor.

The polar anisotropic magnetic element is preferably a ferrite polar anisotropic magnetic ring, to prevent the polar anisotropic magnetic ring from rust and chemical erosion when used in water, to obtain high magnetic flux density and shortest magnetic line path, and to increase output efficiency when the polar anisotropic magnetic ring is coupled to the stator.

The centrifugal water pump of the invention can be an outer-rotor or inner-rotor water pump. In the outer-rotor water pump, magnetic force lines are centrally distributed at the inner surface of the polar anisotropic magnetic ring; in the inner-rotor water pump, magnetic force lines are centrally distributed at the outer surface of the polar anisotropic magnetic ring.

### DESCRIPTION OF THE DRAWINGS

The invention can be more fully understood by reading the subsequent detailed description and examples with references made to the accompanying drawings, wherein:

FIG. 1 is a schematic view showing distribution of magnetic force lines emitted from a conventional anisotropic plastic magnet.

FIG. 2A is a schematic view of a single tiled magnet.

FIG. 2B is a schematic view showing distribution of magnetic force lines emitted from a circular anisotropic element formed by a plurality of tiled magnets. FIG. 3A is a schematic view of an external-rotor centrifugal water pump of the first embodiment of the invention.

FIG. 3B is a schematic view showing distribution of magnetic force lines measured from an inner surface of a polar anisotropic magnetic ring of the water pump of FIG. 3A.

FIG. 4A is a schematic view of an internal-rotor centrifugal water pump of the second embodiment of the invention.

FIG. 4B is a schematic view showing distribution of magnetic force lines measured from an outer surface of a polar anisotropic magnetic ring of the water pump of FIG. 4A.

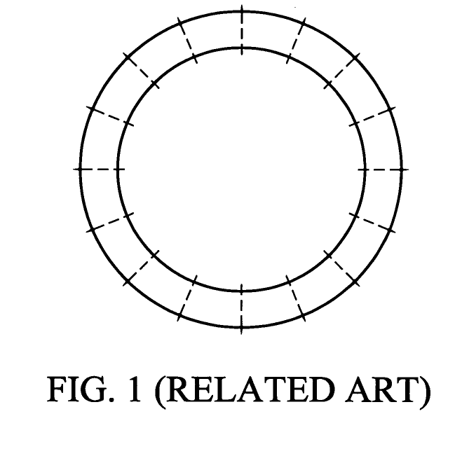

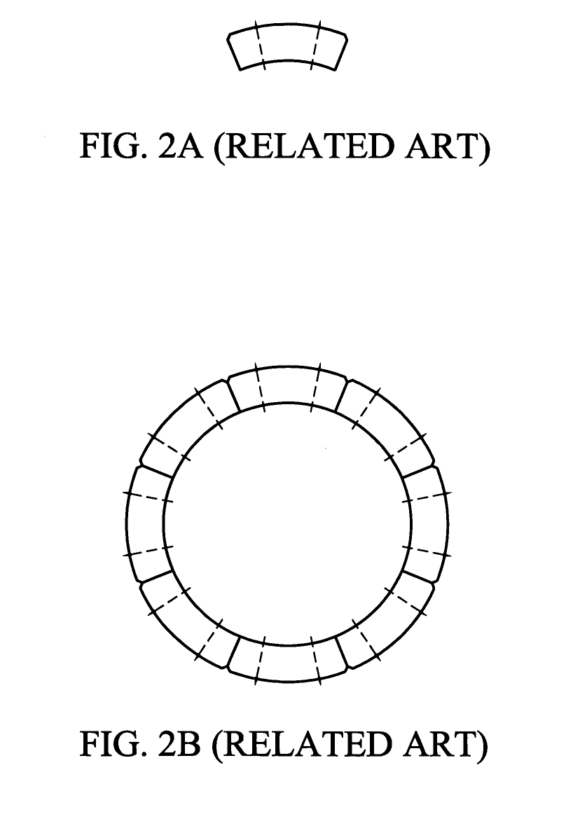

### DETAILED DESCRIPTION

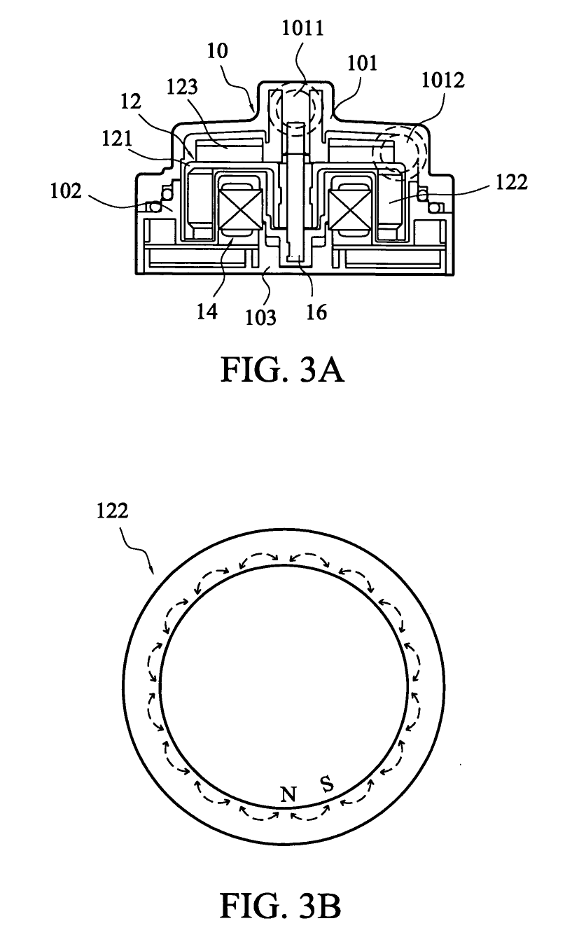

In FIG. 3A, an external-rotor centrifugal water pump P1 of the first embodiment of the invention comprises a housing 10, a rotor 12, a stator 14 disposed in the rotor 12, and a shaft 16 longitudinally penetrating the rotor 12. The rotor 12, the stator 14 and the shaft 16 are enclosed by the housing 10.

The housing 10 comprises a frame 102, a cover 101 disposed on one side of the frame 102, and a bottom plate 103 disposed on one side of the frame 102 with respect to the cover 101. The cover 101 has an inlet 1011 and an outlet 1012 (shown by dotted lines) to transfer water, respectively. An accommodation portion formed between the cover 101 and the frame 102 receives the rotor 12. A closed portion formed between the bottom plate 103 and the frame 102 receives the stator 14. The shaft 16 is fixed to the cover 101 and the frame 102 at both ends thereof.

The rotor 12 comprises a rotator 121 having a top surface, a polar anisotropic magnetic element 122 disposed on the inner wall of the rotator 121, and a plurality of blades 123 disposed on the top surface of the rotator 121. In this embodiment, the rotator 121 is made of plastics, and the polar anisotropic magnetic element 122 is a magnetic ring. A working fluid, e.g. water, passes through the clearance between the rotor 12, the cover 101 and the frame 102.

The stator 14 disposed in the rotor 12 comprises a plurality of stacked silicon-steel sheets and coils wound on the stacked silicon-steel sheets. When the stator 14 coupled to the rotor 12 is electrically powered, electromagnetic force is generated to drive the rotor 12.

FIG. 3B shows distribution of magnetic force lines measured from an inner surface of the polar anisotropic magnetic ring 122 of the external-rotor centrifugal water pump P1. Note that magnetic force lines are centrally distributed at the inner surface of the polar anisotropic magnetic ring 122 to obtain high magnetic flux density and shortest magnetic line path to increase output efficiency when the polar anisotropic magnetic ring 122 is coupled to the stator 14.

The polar anisotropic magnetic ring 122 is preferably made of ferrite. Thus, the magnetic ring 122 can be prevented from rust when used in water and no additional water-proofing element is required. Furthermore, the polar anisotropic magnetic element 122 can be a sintered ferrite polar anisotropic magnetic ring, having magnetic property better than the general ferrite magnet.

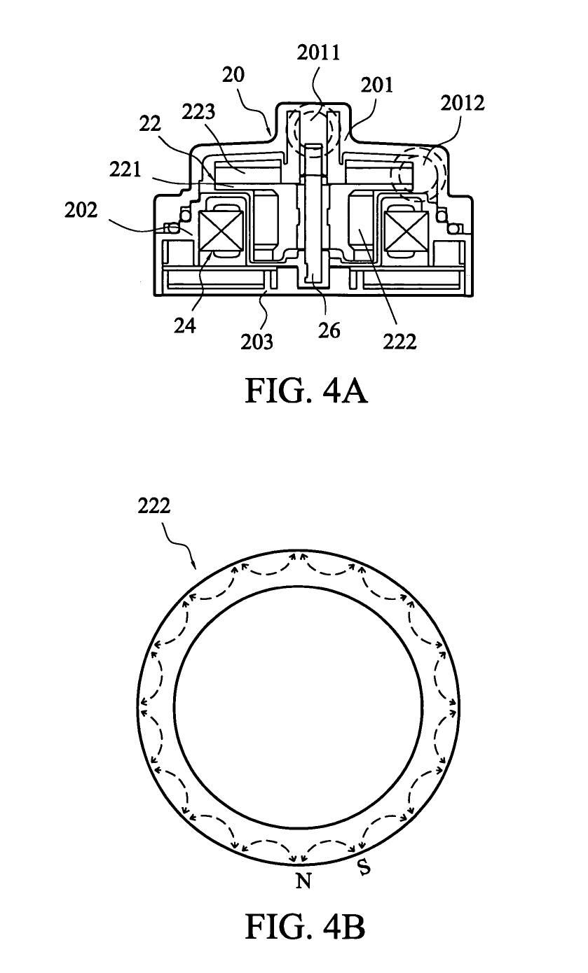

In FIG. 4A, an external-rotor centrifugal water pump P2 of the second embodiment of the invention comprises a housing 20, a rotor 22, a stator 24 disposed in the rotor 22, and a shaft 26 penetrating the rotor 22. The rotor 22, the stator 24 and the shaft 26 are enclosed by the housing 20.

The housing 20 comprises a frame 202, a cover 201 disposed on one side of the frame 202, and a bottom plate 203 disposed on one side of the frame 202 with respect to the cover 201. The cover 201 has an inlet 2011 and an outlet 2012 (shown by dotted lines) to transfer water, respectively. An accommodation portion formed between the cover 201 and the frame 202 receives the rotor 22. A closed portion formed between the bottom plate 203 and the frame 202 receives the stator 24. The shaft 26 is fixed to the cover 201 and the frame 202 at both ends thereof.

The rotor 22 comprises a rotator 121 having a top surface, a polar anisotropic magnetic element 222 disposed on the outer wall of the rotator 121, and a plurality of blades 223 disposed on the top surface of the rotator 121. In this embodiment, the rotator 121 is made of plastics, and the polar anisotropic magnetic element 222 is a magnetic ring. A working fluid, e.g. water, passes through the clearance between the rotor 22, the cover 201 and the frame 202.

The stator 24 disposed in the rotor 22 comprises a plurality of stacked silicon-steel sheets and coils wound on the stacked silicon-steel sheets. When the stator 24 coupled to the rotor 22 is electrically powered, electromagnetic force is generated to drive the rotor 22.

FIG. 4B shows the distribution of magnetic force lines measured from an outer surface of the polar anisotropic magnetic ring 222 of the inner-rotor centrifugal water pump P2. Note that magnetic force lines are centrally distributed at the outer surface of the polar anisotropic magnetic ring 222 to obtain high magnetic flux density and shortest magnetic line path to increase output efficiency when the polar anisotropic magnetic ring 222 is coupled to the stator 24.

The polar anisotropic magnetic ring 222 is preferably made of ferrite. Thus, the magnetic ring 222 can be prevented from rust when used in water and no additional water-proofing element is required. Furthermore, the polar anisotropic magnetic element 222 can be a sintered ferrite magnet polar anisotropic magnetic ring, having magnetic property better than the general ferrite magnet.

With the rust-proof polar anisotropic magnetic ring 222, the centrifugal water pumps P1 and P2 of the invention have magnetic property better than the conventional pump and output a large amount of water at high pressure.

While the invention has been described with respect to preferred embodiment, it is to be understood that the invention is not limited thereto, but, on the contrary, is intended to accommodate various modifications and equivalent arrangements included within the spirit and scope of the appended claims.

What is claimed is:

1. A water pump, comprising:
a housing comprising an inlet and an outlet;
a rotor disposed in the housing and comprising a polar anisotropic magnetic element; and
a stator disposed in the housing with respect to the polar anisotropic magnetic element of the rotor for providing electromagnetic force for driving the rotor.

2. The water pump as claimed in claim 1, wherein the polar anisotropic magnetic element comprises a ferrite polar anisotropic magnetic ring.

3. The water pump as claimed in claim 1, wherein the polar anisotropic magnetic element comprises a sintered ferrite polar anisotropic magnetic ring.

4. The water pump as claimed in claim 1, wherein the polar anisotropic magnetic element has an inner surface with polar anisotropy.

5. The water pump as claimed in claim 4, wherein the stator is disposed in the rotor.

6. The water pump as claimed in claim 1, wherein the polar anisotropic magnetic element has an outer surface with polar anisotropy.

7. The water pump as claimed in claim 6, wherein the stator is disposed outside of the rotor.

8. The water pump as claimed in claim 1 further comprising a shaft longitudinally penetrating the rotor.

9. The water pump as claimed in claim 1, wherein the housing further comprises a cover and a frame connected to the cover to provide an accommodation portion for receiving the rotor.

10. The water pump as claimed in claim 9, wherein the housing further comprises a bottom plate connected to the frame to provide a closed portion for receiving the stator.

11. The water pump as claimed in claim 1, wherein the stator comprises a plurality of stacked silicon-steel sheets and coils.

12. The water pump as claimed in claim 1, wherein the water pump is a centrifugal water pump.

13. The water pump as claimed in claim 1, wherein the rotor further comprises a top surface and a plurality of blades formed on the top surface.
